(19) United States
(12) Patent Application Publication
(10) Pub. No.: US 2016/0001588 A1
(43) Pub. Date: Jan. 7, 2016

(54) DECORATIVE SYSTEM WITH REMOVABLE EMBLEMS FOR COMMEMORATING LIFE EVENTS

(71) Applicant: Lisa B. Montgomery, Ankeny, IA (US)

(72) Inventor: Lisa B. Montgomery, Ankeny, IA (US)

(21) Appl. No.: 14/753,398

(22) Filed: Jun. 29, 2015

Related U.S. Application Data
(60) Provisional application No. 62/019,584, filed on Jul. 1, 2014.

(51) Int. Cl. B44C 5/00

(52) U.S. Cl. CPC B44C 5/00

(57) ABSTRACT

A decorative system with removable sentiments for commemorating life events includes a pendant with a border section and a platform that is at least partially metallic and/or magnetic. A removable and replaceable sentiment is magnetically connected to the pendant. The sentiment includes indicia thereon that commemorate a life event. An adjustable band is connected the sides of pendant 12. The band includes a first section formed of a plurality of decorative links that are connected together and a second section formed of a strand of material. Opposing second sections are connected together by an adjustment member that allows the length of the band to be easily adjusted. The system is placed around a vase, pot, stuffed animal, urn or the like and a sentiment with an appropriate saying is placed on the pendant thereby commemorating a life event.

### CROSS REFERENCE TO RELATED APPLICATION

This application claims the benefit of U.S. Provisional Application No. 62/019,584 filed Jul. 1, 2014.

### FIELD OF THE INVENTION

This invention relates to a decorative system. More specifically, and without limitation, this invention relates to a decorative system with removable sentiments for commemorating life events.

### BACKGROUND OF THE INVENTION

Important life events periodically occur throughout one's life such as birthdays, weddings, anniversaries, births, the passing of loved ones, graduations and the like. It is customary for friends, family and other loved ones to celebrate these life events by giving flowers, stuffed animals, candles, cards or other gifts or mementos. While giving such gifts is certainly appreciated, this custom has, over time, become somewhat generic, and without more, many gifts may lack a desired personal touch.

As an example, people often give the gift of a flower arrangement in a vase. While such a gift is certainly beautiful and sentimental, such a gift lacks any specific and personal message.

As another example, people often give gifts such as stuffed animals or other sentimental objects. Again, while these gifts are certainly appreciated, such a gift lacks any personal message tailored for the particular life event that is being commemorated.

As yet another example, people often give cards or gifts with cards to commemorate life events. While cards allow someone to provide a specific and personal message, many people hate picking out cards and others do not like to write even a short message in cards. In addition, giving a card alone is sometimes perceived as underwhelming and certainly lacks gravitas compared to giving a physical gift. In addition, cards are hard to display.

For the reasons stated above, and for other reasons stated below which will become apparent to those skilled in the art upon reading and understanding the specification, drawings, and claims, there is a need in the art for a decorative system with removable sentiments for commemorating life events.

Thus, it is a primary object of the invention to provide a decorative system with removable sentiments for commemorating life events that improves upon the state of the art.

Another object of the invention is to provide a decorative system with removable sentiments for commemorating life events that is customizable for various life events.

Yet another object of the invention is to provide a decorative system with removable sentiments for commemorating life events that provides an improved aesthetically pleasing appearance.

Another object of the invention is to provide a decorative system with removable sentiments for commemorating life events that is adjustable to fit an endless array of gifts.

Yet another object of the invention is to provide a decorative system with removable sentiments for commemorating life events that can be placed around various objects such as stuffed animals, vases, candles, pots, urns, and the like.

Another object of the invention is to provide a decorative system with removable sentiments for commemorating life events that include various sentimental sayings.

Yet another object of the invention is to provide a decorative system with removable sentiments for commemorating life events that does not require the use of tools to modify.

Another object of the invention is to provide a decorative system with removable sentiments for commemorating life events that is relatively inexpensive to manufacture.

Yet another object of the invention is to provide a decorative system with removable sentiments for commemorating life events that is easy to use.

Another object of the invention is to provide a decorative system with removable sentiments for commemorating life events that enhances the meaning and appearance of a gift.

Yet another object of the invention is to provide a decorative system with removable sentiments for commemorating life events that has a long and useful life.

Another object of the invention is to provide a decorative system with removable sentiments for commemorating life events that can be repurposed for other life events by simply replacing a sentiment.

These and other objects, features, or advantages of the invention will become apparent from the specification and claims.

### SUMMARY OF THE INVENTION

A decorative system with removable sentiments for commemorating life events includes a pendant with a border section and a platform that is at least partially metallic and/or magnetic. A removable and replaceable sentiment is magnetically connected to the pendant. The sentiment includes indicia thereon that commemorate a life event. An adjustable band is connected the sides of pendant 12. The band includes a first section formed of a plurality of decorative links that are connected together and a second section formed of a strand of material. Opposing second sections are connected together by an adjustment member that allows the length of the band to be easily adjusted. The system is placed around a vase, pot, stuffed animal, urn or the like and a sentiment with an appropriate saying is placed on the pendant thereby commemorating a life event.

### BRIEF DESCRIPTION OF THE DRAWINGS

FIG. 1 is a front elevation view of a system that includes an oval pendant with a border section, a sentiment having an inscription thereon is connected to the pendant, and a band is connected to the pendant wherein the first section of the band is formed of a plurality of metallic links with jewels thereon, and the second section of the band is a cord, rope or string that is connected by an adjustable member.

FIG. 2 is a front elevation view of a system that includes an oval pendant with a border section, a sentiment having an inscription thereon is connected to the pendant, and a band is connected to the pendant wherein the first section of the band is formed of a metallic chain formed of a plurality of links with charms connected thereto, and the second section of the band is a cord, rope or string that is connected by an adjustable member.

FIG. 3 is a front elevation view of a system that includes an oval pendant with a border section, a sentiment having an inscription thereon is connected to the pendant, and a band is connected to the pendant wherein the first section of the band is formed of a plurality of strings of beads, many of the beads having the appearance of a pearl, and the second section of the band is a cord, rope or string that are connected to one another by an adjustable member.

FIG. 4 is a front elevation view of a system that includes a round pendant with a border section, a sentiment having an inscription thereon is connected to the pendant, and a band is connected to the pendant wherein the first section of the band is formed of a plurality of metallic links that are formed in a round shape with an undulating surface texture thereon, and the second section of the band is a cord, rope or string that are connected to one another by an adjustable member.

FIG. 5 is a front elevation view of a system that includes a square pendant with a border section, a sentiment having an inscription thereon is connected to the pendant, and a band is connected to the pendant wherein the first section of the band is formed of a plurality of links formed of colorful mother-of-pearl pieces, and the second section of the band is a cord, rope or string that are connected to one another by an adjustable member.

FIG. 6 is a front elevation view of a system that includes a pendant in the shape of a looping cross without a border section, a sentiment with an open center having an inscription several times thereon is connected to the pendant, and a band is connected to the pendant wherein the first section of the band is formed of a plurality of a plurality of metal chains with links, and the second section of the band is a cord, rope or string that are connected to one another by an adjustable member.

FIG. 7 is an elevation view of the back that of a plurality of sentiments, the view showing the recess and magnet of each of the sentiments.

FIG. 8 is a front elevation view of a system placed around a vase, the view showing the system in one manner of use.

FIG. 9 is a front elevation of a workstation for selling the systems, the view showing a plurality of drawers that hold pendants with attached bands and other drawers that hold various sentiments for user selection and assembly.

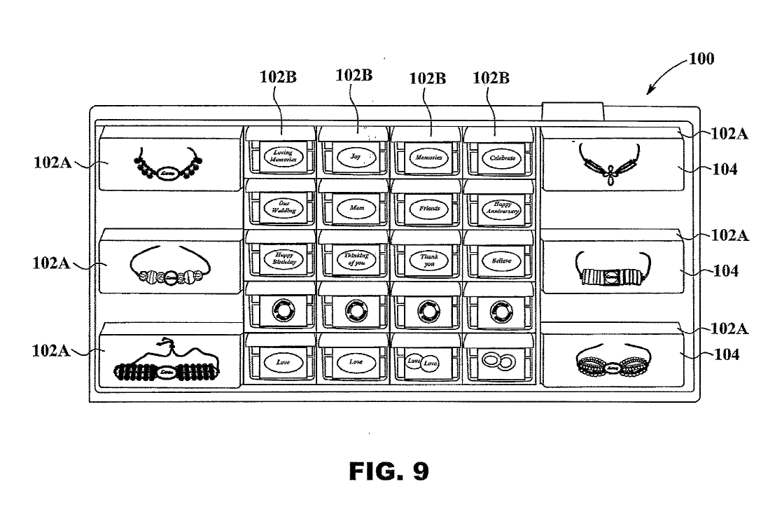

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention. The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end, sides, and the like, are referenced according to the views presented. It should be understood, however, that the terms are used only for purposes of description, and are not intended to be used as limitations. Accordingly, orientation of an object or a combination of objects may change without departing from the scope of the invention.

While the figures show the invention used in association with a vase, the invention is not so limited. A vase is simply used as an example, and the features or advantages of the arrangement can be applied to any form of a gift or other object without limitation.

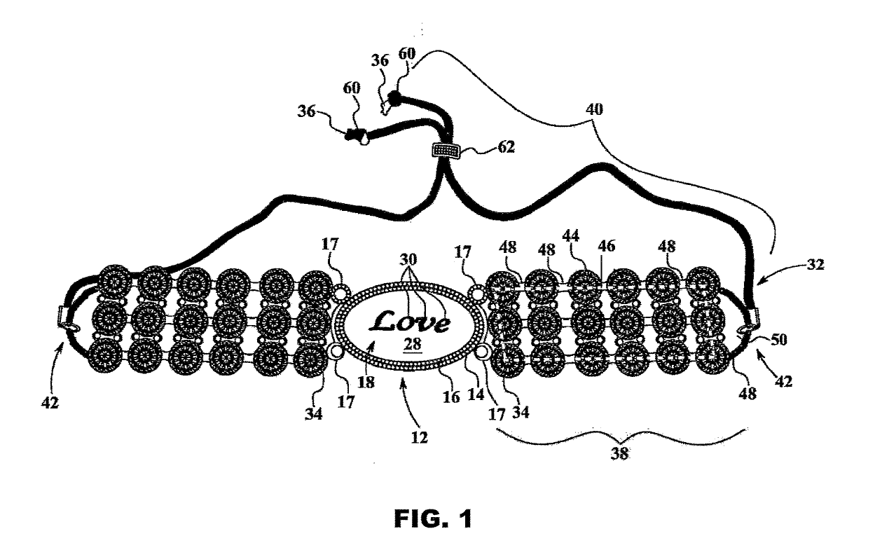

With reference to FIG. 1, a decorative system with removable sentiments for commemorating life events 10 is presented (system 10).

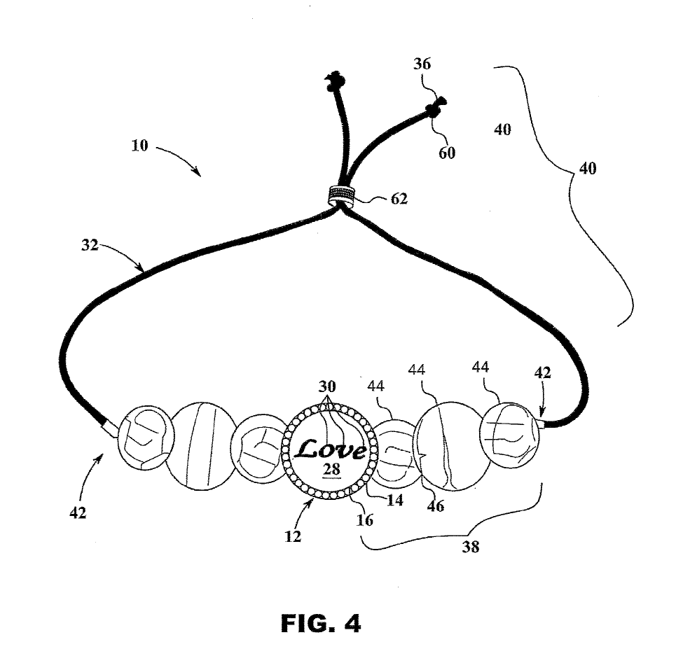

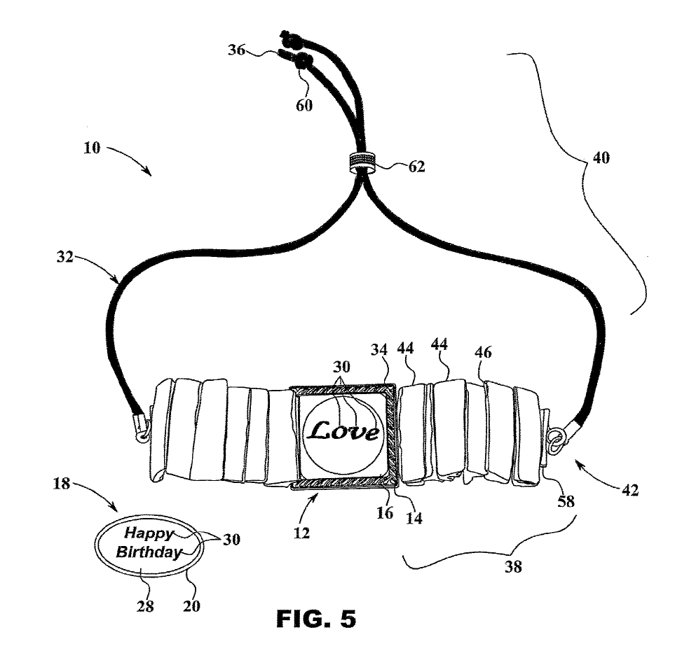

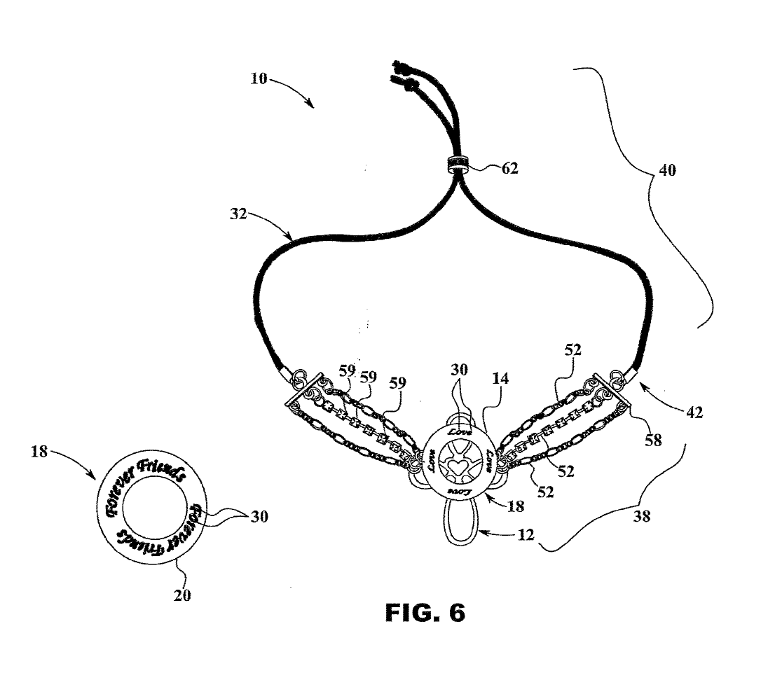

Pendant: The system 10 includes a pendant 12 positioned approximately at the middle of the system 10. Pendant 12 is formed of any suitable size, shape and design. As examples, pendant 12 may be generally oval in shape (FIGS. 1-3), round in shape (FIG. 4), square in shape (FIG. 5), or any other shape or design (see for example FIG. 6 where pendant 12 is formed in a decorative shape such as an aesthetically pleasing design that is similar to two infinity symbols connecting at their middle with one infinity symbol vertically oriented and the other horizontally oriented, the vertically oriented infinity symbol being slightly larger than the horizontal infinity symbol). Pendant 12 may be generally flat from side to side; whereas in an alternative arrangement, pendant 12 accurately curves from side to side so as to better fit around a vase, urn, flower pot, candle or other rounded or curved object.

In one arrangement, as is shown in FIGS. 1-5, pendant 12 includes a border section 14 that extends around the periphery of pendant 12. This border section 14 may include a decorative and aesthetically pleasing pattern, such as texturing, a rope pattern, a chain pattern, or any other pattern, as is shown as one example in FIGS. 1-5. Border section 14 is raised above and surrounds a platform 16. That is, the interior edge of border section 14 defines the area of platform 16. Platform 16 is generally smooth and flat when the pendant 12 is flat, or smooth and curved when pendant 12 is curved.

Alternatively, pendant 12 is generally flat or otherwise is without border section 14 (as is shown in FIG. 6). In one arrangement, pendant 12 is formed, of a ferrous or metallic material, or at least a portion of pendant 12 includes a metallic or ferrous portion such that magnets will be attracted to and connect to this metallic portion of pendant 12. In one arrangement, at least a part or portion of platform 16 is formed of a metallic or ferrous material. Alternatively, in one arrangement, pendant 12 is formed entirely of a magnetic material, or includes a part or portion thereof that is formed of a magnetic material. In one arrangement, pendant 12 is coated with an aesthetically pleasing finish such as a brass, nickel, copper, silver, chrome, bronze, pewter, or any other metallic finish or the like so as to give the look of a precious or semi-precious metal. Alternatively, pendant 12 is painted any other non-metallic color or colors.

Pendant 12 may also include mounting features 17. Mounting features 17 are any form of a feature that allows other components of the system 10 to be mounted thereto as is described herein. In one arrangement, mounting features 17 are openings connected to the outward sides or back of pendant 12 that allow another component, such as a string, chain, clasp or piece to pass through the opening thereby connecting the two components together.

Sentiment: A sentiment 18 is part of system 10. Sentiment 18 is formed of any suitable size shape and design. As examples, sentiment 18 may be generally oval in shape (FIGS. 1-3), round in shape (FIGS. 4-5), round in shape with an open center (FIG. 6), or any other shape or design. Sentiment 18 may be generally flat from side to side so as to match and mate with a similarly flat pendant 12 (as is shown in FIGS. 4-6); whereas in an alternative arrangement, sentiment 18 accurately curves from side to side so as to match and mate with a similarly accurately curved pendant 12 (as is shown in FIGS. 1-3) so as to better fit around a vase, urn, flower pot, candle or other rounded or curved object.

In one arrangement, sentiment 18 is sized and shaped to fit within platform 16 with close tolerances. That is, sentiment 18 is sized and shaped such that the exterior peripheral edge 20 of sentiment 18 fits within close tolerances to the interior edge of border section 14. In this way, border section 14 helps to receive and hold sentiment 18 within platform 16 in proper alignment, and therefore aids with assembly. That is, in this arrangement, platform 16 is recessed with respect to border section 14 and in this way the raised border section 14 makes it easier for the user to install the sentiment 18 onto the platform 16.

In this arrangement, the back surface 22 of sentiment 18 is sized and shaped to mate with the front surface of platform 16. When platform 16 is flat, the back surface 22 of sentiment 18 is flat; when the platform 16 is curved, the back surface 22 of sentiment 18 is curved. In this way, a generally flush mating engagement is provided between the front surface of platform 18 and back surface 22 of sentiment 18.

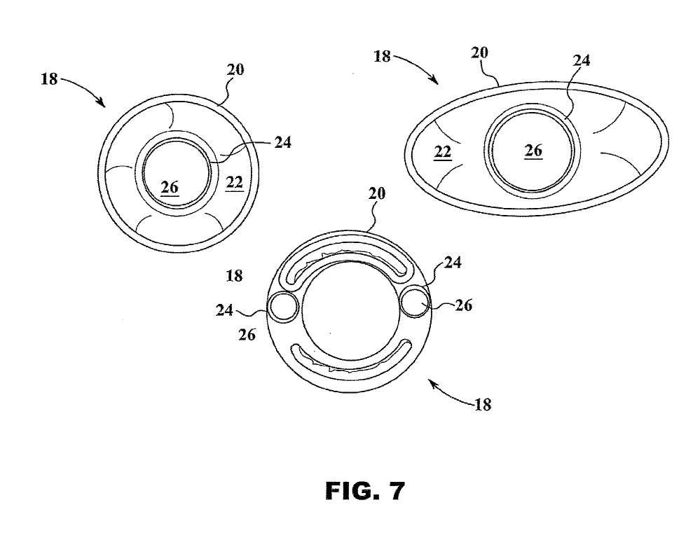

In one arrangement, sentiment 18 is formed, of a ferrous or metallic material, however it is hereby contemplated that sentiment 18 may be formed of any other material. In one arrangement, as is shown in FIG. 7, the back surface 22 includes one or more recesses 24 that receive at least one magnet 26 therein in mating engagement with close and tight tolerances. Magnets 26 can be formed of any suitable size and shape, such as round, square, oval, rectangular or the like. Magnets 26 are secured within recess 24 by any manner such as a frictional fit, magnetic attraction, welding, gluing, adhering, screwing, bolting or the like. In an alternative arrangement, the entirety or majority of sentiment 18 is magnetic thereby obviating the need to add an additional magnetic part or piece. However, by having magnet 26 be a separate piece, while this adds an additional part, this reduces amount of magnetic material needed and thereby may reduce manufacturing costs. In addition, by having two or more magnets 26 connected to sentiment 18 this can be used to maintain a specific orientation of the sentiment 18 on the pendant 12, as is shown in FIG. 6 where the two magnets 26 keep sentiment oriented in a level and consistent manner on pendant 12 so that the indicia 30 can be easily installed and read.

When pendant 12 includes a border section 14 and sentiment 18 is sized and shaped to fit with close tolerances within platform 16, only a single magnet 26 may be used or needed in this application. In this arrangement it may be desirable to position the magnet 26 at approximately the center, or center of mass, of the sentiment 18 so as to provide a strong, secure and well balanced connection.

In an alternative arrangement, when sentiment 18 is to be used on a pendant 12 that has no border section 14 (such as is shown in FIG. 6) two or more of magnets 26 may be connected to the back surface 22 of sentiment 18. The use of two or more magnets 26 helps to assist with alignment of sentiment 18 on pendant 12 since, in this arrangement, no alignment is provided by border section 14. In the arrangement shown, the two magnets 26 are positioned at lateral sides of the sentiment 18 across from one another. In this way, the pair of magnets 26 help to align and hold the sentiment 18 in a square, straight and secure manner to the odd shaped pendant 12. It is hereby contemplated that any number of magnets 26 may be used to provide the proper alignment and strength of hold.

In an alternative arrangement, pendant 12 includes one or more magnets 26. In yet another alternative arrangement, both pendant 12 and sentiment 18 include one or more magnets 26 that align with one another and magnetically cooperate with one another to provide additional strength of hold and additional alignment. In this arrangement, however, care is taken to ensure that the magnetic poles of the magnets of the pendant 12 and sentiment 18 are aligned so that the two components attract to one another, as compared to repel against one another.

The front surface 28 of sentiment 18 is generally smooth, curved and/or flat. Front surface 28 includes indicia 30 thereon. Indicia 30 is any form of marking, such as a design, letters, numbers, a picture or the like. In one arrangement, as is shown, indicia 30 is a word or saying which is recessed into, or protrudes from, or is otherwise three-dimensional on front surface 28 of sentiment 18 to provide better contrast, easy reading, and improved aesthetic appeal. In this arrangement, to further provide better contrast, easy reading, and improved aesthetic appeal, indicia 30 is one color or texture whereas the front surface 28 is another color. As examples, with reference to FIGS. 1-6 and 8, indicia 30 are recessed lettering in the color black whereas the front surface 28 is a metallic coating such as brass, nickel, copper, silver, chrome, bronze, pewter, or the like. Alternatively, indicia 30 are formed of any other suitable size, shape and design, and may be identical, similar or different from the coating used on pendant 12.

Indicia 30 may be formed in any word or saying. By way of example only, indicia 30 may include the words or phrases:
“Happy Anniversary”
“Our Wedding”
“Mom”
“Dad”
“Friends”
“Daughter”
“Son”
“Brother”
“Sister”
“Loving Memory”
“Joy”
“Memories”
“Celebrate”
“Believe”
“Thank You”
“Happy Birthday”
“Thinking of You”
“Forever Friends”
“Forever Family”
“Remember Forever”
“A Gift From God”
“Love”
“Happy”
“Journey”
“Our Home”
“My Sweetheart”
“Happy Holidays”
“Let it Snow!”
“Welcome Home”

In one arrangement, sayings on sentiments can be custom made or made-to-order. In one arrangement, an internet website is presented where customers can order sentiments 18 having a custom indicia 30 thereon, which is then shipped to the customer. In another arrangement, an in-store system is provided at a point of purchase where custom indicia 30 is formed in a blank sentiment 18. This arrangement provides the benefit of meeting a customer's immediate need, or impulse buy, and therefore obviates the lead-time required with mail-ordering the custom sentiment 18.

Band: System 10 includes a band 32. Band 32 is formed of any suitable size, shape and design. In the arrangement shown, band 32 is formed of two halves, one half connecting to one side of pendant 12 and the other half connecting to the other side of pendant 12. Each half of band 32 connects at a first end 34 to one side of pendant 12 and extends a length before terminating at a second end 36. Band 32 is any form of a flexible or malleable connecting device and may be formed of or include, partially or wholly, a cord, strap, chain, a plurality of linked parts, string, rope, or the like.

In the arrangement shown, band 32 includes a first section 38 (which is generally decorative in nature) and a second section 40 (which is generally non-decorative in nature) which connect to one another at a midpoint 42. First section 38 connects at first end 34 to one side of pendant 12 and extends a length before terminating at a midpoint 42. Second section 40 connects to first section 38 and extends a length before terminating at second end 36.

First Section: As one example, (with reference to FIG. 1) first section 38 is formed of a plurality of links 44 that are connected in end-to-end relation by one or more cords 46 that extends through each link 44 connecting them in an end-to-end arrangement. With reference to FIG. 1, cord 46 is shown in a hidden dashed line that extends through links 44. Cord 46 is flexible, and in some arrangements elastic or stretchable, and therefor links 44 flex and/or bend with respect to one another thereby allowing band 32 to conform to practically any shape. More specifically, cord 46 extends through openings in mounting features 17 of pendant 12 and similarly extend through openings in each of the links 44. To provide proper spacing and to improve flexing of links 44 with respect to one another, cord 46 also extends through one or more beads 48 which are positioned between adjacent links 44. Also, cord 46 forms a loop 50 on the outward side of first section 38 which serves as a connecting point to the inward most end of second section 40. In one arrangement, loop 50 is formed by passing cord 46 through a plurality of beads 48, which are similar if not identical to those beads 48 positioned between links 44.

Cord 46 is formed of any flexible device such as wire, string, wire rope, braid, elastic or the like. In the arrangement shown, links 44 are decorative in nature and formed of a metallic material and include an ornamental design with a textured surface that includes inlaid jewels. However, any other design is hereby contemplated for use, such as for example in FIG. 4 a plurality of textured circular metallic disks are used, and as another example in FIG. 5 a plurality of stone, shell, bone or other material parts are used that are of various colors.

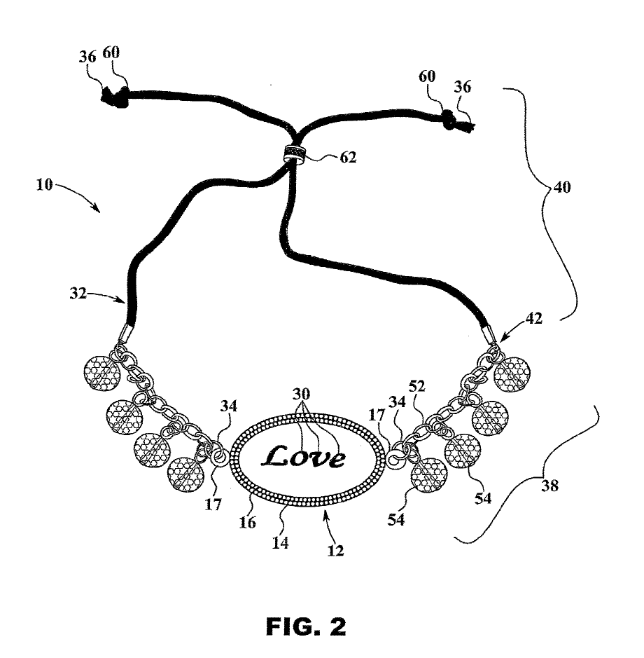

As another example, (with reference to FIG. 2) first section 38 is formed of a chain 52 that connects at its inward end to the opening of mounting feature 17 of pendant 12. Chain 52 is decorative in nature and is formed of a plurality of links that are connected in end-to-end relation to one another and extend a length. A plurality of charms 54 are connected to and hang down from chain 52 at various spacing thereby providing an improved aesthetic appearance. In the arrangement shown, the charms are clear beads that mimic jewels, however any other type of charm 54 is hereby contemplated for use.

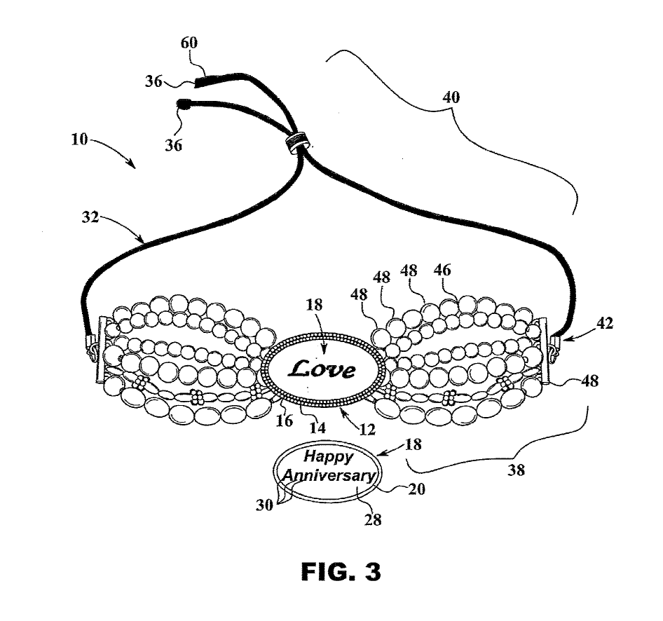

As yet another example, (with reference to FIG. 3) first section 38 is formed of a plurality of strands of beads 48 connected in end-to-end relation to one another by cord 46 that extends through the beads 48. The inward end of cord 46 connects to openings in mounting features 17 and the outward end of cord 46 connects to openings in bracket 58. In this arrangement, beads 48 are formed of any design or shape or color or texture. In the arrangement shown, as an example, beads 48 have a metallic or pearl-like appearance.

As another example, (with reference to FIG. 5) first section 38 is formed of a plurality of links 44 that are connected together in end-to-end relation to one another by cords 46 that extend through each link 44. The inward end of cords 46 connect to openings in mounting features 17 of pendant 12 and the outward end of cord 46 connects to openings in bracket 58. In this arrangement, links are colorful and decorative pieces of material, such as plastic, wood, bone, shell or the like. More specifically, in the arrangement shown, links 44 are formed of colorful pieces of mother-of-pearl shell, or mother-of-pearl shell-like material. In this arrangement, cord 46 is elastic, or elastic in nature, thereby allowing the links 44 to stretch or separate with respect to one another.

As yet another example, (with reference to FIG. 6) first section 38 is formed of a plurality of decorative chains 52 that connect at their inward end to pendant 12 and at their outward end to bracket 58. In this arrangement, the chains 52 are decorative in nature having a plurality of links connected in end-to-end relation wherein the links are formed of different sizes and arranged in a decorative pattern. In addition, at least one chain 52, in this arrangement the center chain 52, includes inlaid jewels 59 therein that improve aesthetic appearance. In this arrangement, the inward ends of chains 52 actually connect around a portion of pendant 12.

Second Section: Second section 40 connects at its inward end to cord 46 or bracket 58, depending on the design of the first section 38, and extends to second end 36. Second section 40 is formed of any suitable size, shape and design. In one arrangement, second section 40 is less decorative than first section 38. This is because second section 40 is often hidden from view when in use and therefore to minimize cost and improve functionality of the design second section 40 may be formed of only a single strand, cord, rope or string, or the like as is shown as an example. Using a single strand, cord, rope or string for second section 40 allows a user to quickly and easily tighten the system 10 around an object 80. This could not be easily done using first section 38 alone as first section 38 is more-decorative than second section 40 and therefore opposing first sections 38 could not be easily connected together in a tightenable fashion.

In the arrangement shown, second section 40 includes a stop 60, such as a knot in the rope or string used for second section 40, or other obstruction to prevent an adjustment member 62 positioned over the two second sections 40 from unintentionally coming off the second end 36 of second section 40.

Adjustment Member: An adjustment member 62 connects opposing second sections 40 together in an adjustable manner. Adjustment member 62 is any device that connects the two opposing second sections 40 together and allows for adjustment of the length of the system 10. In the arrangement shown, adjustment member 62 includes an opening therein that receives the two second sections 40 there through. The opening in adjustment member is sized and shaped such that the two second sections 40 are received therein with close and tight frictional tolerances. In this arrangement, adjustment member 62 imparts enough friction upon the opposing second sections 40 so as to hold any position on second sections 40. This arrangement also allows the length of the second sections 40 to be adjusted by a user pulling one or both of the second sections 40 through the adjustment member 62 with an amount of force that exceeds the frictional hold imparted by adjustment member 62 onto second sections 40. In this way, adjustment member allows a user to adjust the length of the system 10 to any length between the mid-point 42 and stop 60. In one arrangement, adjustment member 62 is generally cylindrical in shape with a decorative exterior surface and a smooth or roughened interior surface. In one arrangement, adjustment member 62 is formed of a metallic material, or has a coating that gives the appearance of metal that is similar to or identical to the coating of pendant 12 and/or sentiment 18.

In Operation: When commemorating a life event, such as a wedding, anniversary, birthday, or the like, an object 80 such as a vase of flowers, an urn, a stuffed animal, a flower pot, a candle or any other object 80 is purchased as a gift to commemorate the event. Next, to improve the appearance of the object 80 and enhance its emotional and personal meaning, the user selects a decorative system 10.

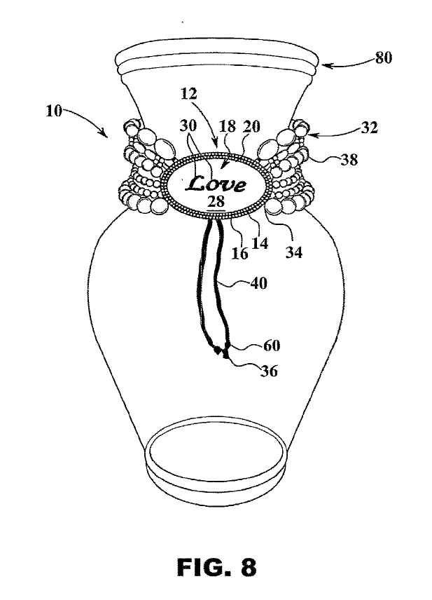

Next the user places the system 10 around the object 80. As an example, (with reference to FIG. 8) the user places the band 32 around the neck of the vase 82. Next, the user tightens the second section 36 of the band 32 by pulling the second ends 36 of second section 40 while holding adjustment member 62. This causes adjustment member 62 to cinch against object 80 thereby holding system 10 onto object 80.

Next the user selects a sentiment 18 with the appropriate indicia 30 thereon. That is, if the object 80 is to commemorate an anniversary, then an sentiment 18 with indicia 30 stating “Our Anniversary” is selected; if the object is to commemorate a birthday, then an sentiment 18 with indicia 30 stating “Happy Birthday” is selected, if the object 80 is to commemorate a graduation, then an sentiment 18 with indicia 30 stating “Happy Graduation” is selected and so on.

Once the sentiment 18 is selected, it is placed on pendant 12. This is done by aligning the back surface 22 of sentiment 18 with the platform 16 of pendant 12. Once the sentiment 18 is placed close enough to the pendant 12 the magnetic force of magnet(s) 26 pulls the sentiment 18 into contact with pendant 12 thereby holding it in place. When a raised border section 14 is present around platform 16, raised border section 14 helps to center the exterior peripheral edge 20 of sentiment 18 within the interior edge of border section 14, ensuring proper alignment and improving hold.

Once the sentiment 18 is installed onto pendant 12, the object 80 is ready for presentation with a personalized message and an improved aesthetic appearance.

First Method of Selling: One manner of selling system 10 is by placing various pendants 12 with various first sections 38 around display cards. Display cards provide a frame to which the system 10 is mounted on and held by and in addition provides an aesthetically pleasing way of showing how system 10 is used. That is, the display card may include one or more images that show how system 10 is used. That is, display card 10 may include images of an object 80, such as a vase, urn, stuffed animal, a flower pot or the like, which shows system 10 is wrapped there around. This way, a potential purchaser upon seeing the display card quickly understands how system 10 is used.

The display card with system 10 mounted thereto is then packaged in a plastic sleeve that is sealed. A plurality of display cards with an assortment of various embodiments of system 10 are then mounted on display stand in a store such as a boutique gift store, a flower store, or the like. In one arrangement the display stand rotates allowing a potential buyer to rotate the stand to see various systems 10 so that they can easily pick out a system that is perfect for the particular life event they are commemorating.

In addition to displaying various complete systems 10, display stand may also include a plurality of individually packaged or loose sentiments 18 to go along with the systems 10. That is, a purchaser may also buy additional sentiments 18 to swap out or replace the sentiment 18 that came with their system 10 so as to use the system 10 to commemorate a new life event.

Second Method of Selling: Another manner of selling system 10 is by placing a workstation 100 at a place of business, such as a flower shop, a gift store or other like business. Workstation 100 includes a plurality of drawers 102 that hold individual components of the system 10. That is, first drawers 102A are dedicated to holding various pendants 12 with bands 32 and second drawers 102B are dedicated to holding various sentiments 18. As one example, in the arrangement shown, a plurality of columns of vertically stacked small second drawers 102B are positioned adjacent the middle of workstation 100. A column of large first drawers 102A are positioned at each outward side of the columns of smaller second drawers 102B. In this arrangement, each of the larger first drawers 102A hold a plurality of the same pendants 12 with bands 32, and each of the smaller second drawers 102B hold a plurality of the same sentiments 18.

The face of each of the drawers 102 include a label 104 that indicates, with a picture and/or text, what part is held within the drawer 102 with a label and part number. This way, a user can quickly and easily select which component of the system to use for the particular life event.

This arrangement also allows for the elimination of much of the packaging materials used when the components of the system 10 are placed on customer display. Reducing the packaging reduces the cost and improves the profit margins.

From the above discussion and the accompanying drawings and claims it will be appreciated that the decorative system with removable sentiments for commemorating life events motorized presented offers many advantages over the prior art. That is, the system presented: improves upon the state of the art; is customizable for various life events; provides an aesthetically pleasing appearance; has an adjustable length to fit any object; can be placed around various objects such as stuffed animals, vases, candles, pots, urns, and the like; includes various sentimental sayings; does not require the use of tools to modify; is relatively inexpensive to manufacture; has removable sentiments for commemorating life events that are easy to use; enhances the meaning and appearance of a gift; has a long and useful life; is reusable; can be repurposed for other life events by simply replacing an sentiment; among countless other advantages and improvements.

It will be appreciated by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in light thereof will be suggested to persons skilled in the art and are to be included within the spirit and purview of this application.

What is claimed:

1. A decorative system with removable sentiments for commemorating life events, comprising:
a pendant having opposing sides;
the pendant having a platform;
a band connected to each side of the pendant;
the bands extending a length form a first end to a second end and having a first section and a second section, wherein the first section is decorative in nature and the second section is non-decorative in nature;
an adjustment member connected to the second sections of the bands;
the adjustment member configured to adjust the length of the bands;
a sentiment removably connected to the platform of the pendant by at least one magnet;
the sentiment having indicia thereon that commemorates a life event; and
wherein the decorative system is configured to be placed around an object and the object is presented as a gift for commemorating a life event.

2. The system of claim 1 wherein the second section is formed of a cord, rope or string.

3. The system of claim 1 further comprising a raised border section that surrounds the platform, wherein the border section provides alignment for the sentiment when the sentiment is placed on the platform.

4. The system of claim 1 further comprising a raised border section that surrounds the platform, wherein when the sentiment is placed on the platform an exterior peripheral edge of the sentiment aligns with an inner edge of the border section.

5. The system of claim 1, wherein the at least one magnet is connected to the sentiment and the pendant is formed at least partially of a magnetic metallic material.

6. The system of claim 1, wherein the at least one magnet is connected to the platform and the sentiment is formed at least partially of a magnetic metallic material.

7. The system of claim 1, wherein the at least one magnet is connected to the platform and at least one magnet is connected to the sentiment.

8. The system of claim 1, wherein a pair of magnets are connected to the sentiment.

9. A kit for commemorating life events, comprising:
a plurality of pendants with bands connected to the pendants;
the pendants having a platform;
the bands extending a length form a first end to a second end and having a first section and a second section, wherein the first section is decorative in nature and the second section is non-decorative in nature;
an adjustment member connected to the second sections of the bands;
the adjustment member configured to adjust the length of the bands;
a plurality of sentiments;
the sentiments configured to be removably connected to the platform of the pendant by at least one magnet;
the sentiments having indicia, such as a word or a phrase, thereon that commemorates a life event;
wherein the decorative system is configured to be placed around an object to commemorate a life event;
wherein a user selects a desired pendant from the plurality of pendants;
wherein the user selects a sentiment from the plurality of sentiments;
wherein the user places the selected sentiment on the platform of the selected pendant; and
wherein the decorative system is placed around an object ant the object presented as a gift for commemorating a life event.

10. The kit of claim 9, further comprising a workstation, wherein the plurality of pendants and the plurality of sentiments are stored in drawers of a workstation.

11. A method of commemorating life events, the steps comprising:
providing a plurality of pendants with bands connected to the pendants on display at a point of purchase;
the pendants having a platform;
the bands extending a length form a first end to a second end and having a first section and a second section, wherein the first section is decorative in nature and the second section is non-decorative in nature;
an adjustment member connected to the second sections of the bands;
the adjustment member configured to adjust the length of the bands;
providing a plurality of sentiments on display at a point of purchase;
the sentiments configured to be removably connected to the platform of the pendant by at least one magnet;
the sentiments having indicia, such as a word or a phrase, thereon that commemorates a life event;
selecting a desired pendant from the plurality of pendants;
selecting a desired sentiment from the plurality of sentiments that commemorates a life event;
placing the selected sentiment on the platform of the selected pendant;
placing the bands of the selected pendant around an object;
tightening the bands around the object; and
giving the object with the pendant thereon as a gift.
